(19) United States
(12) Patent Application Publication
(10) Pub. No.: US 2007/0149434 A1
(43) Pub. Date: Jun. 28, 2007

(54) Lipophilic fluid cleaning compositions

(76) Inventors: Keith Homer Baker, Cincinnati, OH (US); Donna Jean Haeggberg, Cincinnati, OH (US); William Michael Scheper, Guilford, IN (US); Gregory Scot Miracle, Hamilton, OH (US); John Christian Haught, West Chester, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/713,129

(22) Filed: Mar. 2, 2007

Related U.S. Application Data
(62) Division of application No. 10/874,846, filed on Jun. 23, 2004.
(60) Provisional application No. 60/483,349, filed on Jun. 27, 2003.

(51) Int. Cl. C11D 3/00

(52) U.S. Cl. 510/375; 510/424

(57) ABSTRACT

The present invention relates to compositions that can be used to provide lipophilic fluids with bleaching capabilities, lipophilic fluid cleaning compositions having bleaching capabilities and processes of making and using same. Such compositions provide the cleaning benefits of typical lipophilic solvents and additional cleaning benefits that include bleaching.

### CROSS-REFERENCES TO RELATED APPLICATIONS

This application is a Divisional Application of copending U.S. patent application Ser. No. 10/874,846, filed on Jun. 23, 2004, which claims the benefit of priority under 35 USC §1.19(e) to U.S. Provisional Application Ser. No. 60/483,349 filed Jun. 27, 2003.

### FIELD OF THE INVENTION

The present invention relates to lipophilic fluid cleaning compositions having bleaching capabilities, and processes of making and using same.

### BACKGROUND OF THE INVENTION

Certain fabric types and constructions require dry cleaning. Dry cleaning typically involves the use of non-aqueous, lipophilic fluids as the solvent or cleaning solution. While cleaning with lipophilic fluids eliminates or minimizes fabric damage, lipophilic fluids have poor hydrophilic and/or combination soil removal capabilities. However, such soils may be efficiently removed by cleaning additives. Unfortunately cleaning additives, such as conventional bleaching materials are sparingly soluble, and ineffective in lipophilic fluids as such materials deposit unevenly on fabrics thus causing fabric damage. As a result, pre-treating and/or pre-spotting compositions are used to remove tough soils. As pre-treating and/or pre-spotting are time consuming and generally limited to spot removal there is a need for compositions that can be used to provide a lipophilic fluid with bleaching capabilities, lipophilic fluid cleaning compositions having bleaching capabilities and processes of making and using same.

### SUMMARY OF THE INVENTION

The present invention relates to compositions that can be used to provide a lipophilic fluid with bleaching capabilities, lipophilic fluid cleaning compositions having bleaching capabilities and processes of making and using same.

These and other aspects, features and advantages will become apparent to those of ordinary skill in the art from a reading of the following detailed description and the appended claims.

### DETAILED DESCRIPTION OF THE INVENTION

Definitions

The term “fabrics” and “fabric” used herein is intended to mean any article that is customarily cleaned in a conventional laundry process or in a dry cleaning process. As such the term encompasses articles of clothing, linen, drapery, and clothing accessories. The term also encompasses other items made in whole or in part of fabric, such as tote bags, furniture covers, tarpaulins and the like.

The term “soil” means any undesirable substance on a fabric. By the terms “water-based” or “hydrophilic” soils, it is meant that the soil comprised water at the time it first came in contact with the fabric article, or the soil retains a significant portion of water on the fabric article. Examples of water-based soils include, but are not limited to beverages, many food soils, water soluble dyes, bodily fluids such as sweat, urine or blood, outdoor soils such as grass stains and mud.

As used herein, “activator” means any compound which when used in conjunction with a hydrogen peroxide source leads to the in situ production of the peracid corresponding to the bleach activator.

As used herein, the articles a and an when used in a claim, for example, “an emulsifier” or “a peracid” is understood to mean one or more of the material that is claimed or described.

Unless otherwise noted, all component or composition levels are in reference to the active level of that component or composition, and are exclusive of impurities, for example, residual solvents or by-products, which may be present in commercially available sources.

All percentages, ratios and proportions herein are by weight, unless otherwise specified. All temperatures are in degrees Celsius (° C.) unless otherwise specified. All measurements are in SI units unless otherwise specified. All documents cited are in relevant part, incorporated herein by reference.

Lipophilic Fluid Cleaning Compositions Having Bleaching Capabilities

In use versions of Applicants' cleaning compositions may comprise from about 10 ppm to about 2,000 ppm, from about 30 ppm to about 1,000 ppm, or even from about 80 ppm to about 500 ppm of a peracid; from about 1,000 ppm to about 50,000 ppm, from about 2,000 ppm to about 30,000 ppm, or from even from about 5000 ppm to about 20,000 ppm water; and from about 20 ppm to about 50,000 ppm, from about 100 ppm to about 3,000 ppm, or even 500 ppm to about 2,000 ppm of an emulsifier; with the balance of said cleaning compositions being a lipophilic fluid or a mixture of a lipophilic fluid and an adjunct ingredient such as a chelant wherein said chelant may be present at a level of least 10 ppb, from 10 ppb to about 200 ppm, from about 50 ppb to about 100 ppm, or even from about 100 ppb to about 50 ppm.

Said in use versions of Applicants' cleaning composition typically comprise a dispersion comprising at least a first and second phase. Said first phase may be an aqueous phase that may have a pH of from about 3 to about 10, from about 4 to about 9 or even from about 5 to about 9. Said first phase may comprise, based on the total weight of peracid in said composition, from about 50% to about 100%, from about 95% to about 100% or even from about 99% to about 100%, of said cleaning composition's peracid. Said second phase is typically a non-aqueous continuous phase that typically comprises the lipophilic fluid.

In one aspect of Applicants' in use cleaning composition, in a 1 mL sample of said cleaning composition, greater than about 0.95 weight fraction of the first phase is contained in droplets, each droplet having an individual weight of less than 1 wt %, less than 0.5 wt %, and even less than 0.1 wt % of the total mass of the first phase in said 1 mL sample. For purposes of the present invention, droplet weight is determined according to ISO 13320-1:1999(E) titled “Particle size analysis—Laser diffraction methods”.

In one aspect of Applicants' in use cleaning composition, said first phase forms discrete droplets having a median particle diameter χ₅₀ of less than about 1000 μm, or less than about 500 μm, or less than about 100 μm. The median particle size is determined by the test method ISO 13320-1:1999(E), wherein χ₅₀ is defined as “median particle diameter, μm; on a volumetric basis, i.e., 50% by volume of the particles is smaller than this diameter and 50% is larger. In some embodiments, the median particle size of the first phase droplet ranges from about 0.1 to about 1000 μm, or from about 1 to about 500 μm, or from about 5 to about 100 μm.

Process of Making

In use versions of Applicants' cleaning compositions may be made by combining a bleaching composition comprising an emulsifier, bleaching materials used to make a bleaching composition and an emulsifier, or mixtures thereof with a lipophilic fluid in a manner such that a cleaning composition comprising a dispersion comprising at least a first and second phase is formed.

In one aspect of Applicants' process, an in use cleaning composition, wherein in a 1 mL sample of said cleaning composition, greater than about 0.95 weight fraction of the first phase is contained in droplets, each droplet having an individual weight of less than 1 wt %, less than 0.5 wt %, and even less than 0.1 wt % of the total mass of the first phase in said 1 mL sample can be made. For purposes of the present invention, droplet weight is determined according to ISO 13320-1:1999(E) titled “Particle size analysis—Laser diffraction methods”.

In one aspect of Applicants' process, an in use cleaning composition is formed, wherein said first phase forms discrete droplets having a median particle diameter χ₅₀ of less than about 1000 μm, or less than about 500 μm, or less than about 100 μm. In certain embodiments, the median particle size of the first phase droplet ranges from about 0.1 to about 1000 μm, or from about 1 to about 500 μm, or from about 5 to about 100 μm. The median particle size is determined by the test method ISO 13320-1:1999(E), wherein χ₅₀ is defined as “median particle diameter, μm; on a volumetric basis, i.e., 50% by volume of the particles is smaller than this diameter and 50% is larger.

A cleaning composition having the aforementioned characteristics may be obtained by employing mechanical shear during and after the requisite components are combined.

Method of Use

Items, including but not limited to fabrics, may be cleaned by contacting said item with an in use version of Applicants' lipophilic fluid cleaning composition having bleaching capabilities. As will be appreciated by the skilled artisan, contacting includes but is not limited to, immersion and spraying. When said cleaning composition's peracid is made from a combination of a bleach activator and a source of hydrogen peroxide, said cleaning composition may be allowed to react for a sufficient period of time to form a desired level of peracid. In such case, said item is typically contacted with said cleaning composition between 1 minute and 60 minutes after the components of said cleaning composition are combined to form said cleaning composition, between 5 minutes and 30 minutes after the components of said cleaning composition are combined to form said cleaning composition, or even between 10 minute and 20 minutes after the components of said cleaning composition are combined to form said cleaning composition.

Bleaching Compositions

Applicants have discovered that certain bleaching compositions are unexpectedly suitable for incorporation into lipophilic fluids as such compositions can be readily dispersed in lipophilic fluids. Suitable bleaching compositions typically comprise an activated peroxygen source, a chelant, and water with any remaining balance being an optional/adjunct ingredient. Such compositions may be made by combining the components listed above in the percentages listed below.

When the bleaching composition of the present invention is formulated with a bleach activator and a source of hydrogen peroxide, a chelant and water, the bleach activator may be present at levels of from about 0.05%, from about 0.05% to about 40%, from about 0.1% to about 35%, or even from about 0.5% to about 35% by weight of the composition; the source of hydrogen peroxide may be present at levels of from about 0.05%, from about 0.05% to about 40%, from about 0.1% to about 35%, or even from about 0.5% to about 35% by weight of the composition; the chelant may be present at levels of from about 0.001%, from about 0.001% to about 5%, from about 0.05% to about 4%, or even from about 0.01% to about 3% by weight of the composition; and water may be present at levels of from about 30%, from about 30% to about 99%, from about 40% to about 98%, or even from about 50% to about 95% by weight of the composition. Said bleaching compositions typically have a pH of from about 8.25 to about 11.0, from about 8.5 to about 10.75, or even from about 8.75 to about 10.5; a ratio of mass of water to mass of solids of from about 10:1 to about 1:2, from about 7:1 to about 1:1 or even from about 5:1 to about 1.2:1; a mole ratio of H₂O₂ to bleach activator of from about 10:1 to about 1:1, or even from about 3:1 to about 1:1; and a ratio of solubility (expressed as mass per unit volume) of bleach activator in water to solubility of activator in the lipophilic fluid, to which the bleaching composition will be added, of greater than 1:1, greater than 3:1, or even greater than 10:1.

When the bleaching composition of the present invention is formulated with a preformed peracid, a chelant and water, the preformed peracid may be present at levels of from about 0.1%, from about 0.1% to about 70%, from about 1% to about 60%, or even from about 5% to about 50% by weight of the composition; the chelant may be present at levels of from about 0.1%, from about 0.1% to about 80%, from about 1% to about 70%, or even from about 5% to about 60% by weight of the composition and water may be present at levels of from about 0.001%, from about 0.001% to about 5%, from about 0.005% to about 4%, or even from about 0.01% to about 3% by weight of the composition. Said bleaching compositions typically have a pH of less than about about 11, less than about 9.5, or even less than about 9; a ratio of mass of water to mass of solids of from about 10:1 to about 1:2, from about 7:1 to about 1:1 or even from about 5:1 to about 1.2:1; and a ratio of solubility (expressed as mass per unit volume) of preformed peracid in water to solubility of preformed peracid in the lipophilic fluid, to which the bleaching composition will be added, of greater than 1:1, greater than 3:1, or even greater than 10:1.

The aforementioned bleaching compositions may be packaged in a kit containing instructions for use.

Suitable Materials

Suitable materials for making Applicants' lipophilic fluid cleaning compositions having bleaching capabilities and bleaching compositions are as follows:

Suitable activated peroxygen sources include, preformed peracids, a hydrogen peroxide source in combination with an activator, or a mixture thereof. Suitable preformed peracids include, but are not limited to, compounds selected from the group consisting of percarboxylic acids and salts, for example, monoperoxyphthalic acid (magnesium salt hexahydrate) amidoperoxyacids, e.g. monononylamide of either peroxysuccinic acid (NAPSA) or of peroxyadipic acid (NAPAA), N-nonanoylaminoperoxycaproic acid (NAPCA), 1,12-diperoxydodecanedioic acid, and N,N′ Terephthaloyl-di(6-aminocaproic acid), percarbonic acids and salts, perimidic acids and salts, peroxymonosulfuric acids and salts, and mixtures thereof. Suitable sources of hydrogen peroxide include, but are not limited to, compounds selected from the group consisting of perborate compounds, percarbonate compounds, perphosphate compounds and mixtures thereof.

Suitable bleach activators include, but are not limited to, tetraacetyl ethylene diamine (TAED), benzoylcaprolactam (BzCL), 4-nitrobenzoylcaprolactam, 3-chlorobenzoylcaprolactam, benzoyloxybenzenesulphonate (BOBS), nonanoyloxybenzenesulphonate (NOBS), phenyl benzoate (PhBz), decanoyloxybenzenesulphonate (C₁₀-OBS), benzoylvalerolactam (BZVL), octanoyloxybenzenesulphonate (C₈-OBS), perhydrolyzable esters, perhydrolyzable imides and mixtures thereof.

Suitable chelants include organic phosphonates, amino carboxylates, polyfunctionally-substituted aromatic compounds, nitriloacetic acid and mixtures thereof. Organic phosphonates suitable for use as chelating agents in the compositions of the present invention, may be selected from ethylenediaminetetrakis (methylenephosphonates) available under the trademark DEQUEST™ from Solutia, diethylene triamine penta (methylene phosphonate), ethylene diamine tri (methylene phosphonate), hexamethylene diamine tetra (methylene phosphonate), α-hydroxy-2-phenyl ethyl diphosphonate, methylene diphosphonate,hydroxy 1,1-hexylidene, vinylidene 1,1 diphosphonate, 1,2 dihydroxyethane 1,1 diphosphonate and hydroxyethylene 1,1 diphosphonate. While not required, such amino phosphonates may not contain alkyl or alkenyl groups with more than 6 carbon atoms. Amino carboxylates chelating agents include ethylene-diaminetetracetates, ethylenediamine disuccinate, N-hy-droxyethylethylenediamine triacetates, 2-hydroxypropylene diamine disuccinate, nitrilotriacetates, ethylenediamine tetraproprionates, triethylenetetraaminehexacetates, ethylene triamine pentaacetate, diethylenetriaminepentaacetates, and ethanoldiglycines, alkali metal, ammonium, and substituted ammonium salts and mixtures thereof. Certain amino carboxylates chelants for use herein are ethylenediamine disuccinate (“EDDS”), such as [S,S] isomer as described in U.S. Pat. No. 4,704,233, ethyl-enediamine-N,N′-diglutamate (EDDG) and 2-hydroxypropylenediamine-N,N′-disuccinate (HPDDS) compounds. Another suitable amino carboxylate chelant is ethylenediamine disuccinate. Poly-functionally-substituted aromatic chelating agents are also useful in the compositions herein. See U.S. Pat. No. 3,812,044. Certain compounds of this type in acid form are dihydroxydisulfobenzenes such as 1,2-dihydroxy-3,5-disulfobenzene. Such chelants include diphosphonate derivatives of the organic phosphonate chelants selected from α-hydroxy-2 phenyl ethyl diphosphonate, methylene diphosphonate, hydroxy 1,1-hexylidene, vinylidene 1,1 diphosphonate, 1,2 dihydroxyethane 1,1 diphosphonate and hydroxyethylene 1,1 diphosphonate. ilydroxyethylene 1,1 diphosphonate is particularly useful.

Suitable emulsifiers may be selected from the group consisting of siloxane-based surfactants, anionic surfactants, nonionic surfactants, cationic surfactants, zwitterionic surfactants, ampholytic surfactants, semi-polar nonionic surfactants, gemini surfactants, amine surfactants, fluorosurfactants and mixtures thereof. The emulsifying agent/surfactant may be soluble in the lipophilic fluid.

One class of emulsifying agent/surfactant can include siloxane-based surfactants (siloxane-based materials) The siloxane-based surfactants in this application may be siloxane polymers for other applications. The siloxane-based surfactants typically have a weight average molecular weight from 500 to 20,000 daltons. Such materials, derived from poly(dimethylsiloxane), are well known in the art. In the present invention, not all such siloxane-based surfactants are suitable, because they do not provide improved cleaning of soils compared to the level of cleaning provided by the lipophilic fluid itself.

Suitable siloxane-based surfactants comprise a polyether siloxane having the formula:
MₐD_{b}D′_{c}D″_{d}M′₂₋ₐ
wherein a is 0-2; b is 0-1000; c is 0-50; d is 0-50, provided that a+c+d is at least 1;

M is R¹₃₋ₑXₑSiO_{1/2} wherein R¹ is independently H, or a monovalent hydrocarbon group, X is hydroxyl group, and e is 0 or 1;

M′ is R²₃SiO_{1/2} wherein R² is independently H, a monovalent hydrocarbon group, or (CH₂)_{f}(C₆Q₄)_{g}O—(C₂H₄O)ₕ—(C₃H₆O)ᵢ(CₖH₂ₖ)ⱼ—R³, provided that at least one R² is (CH₂)_{f}(C₆Q₄)_{g}O—(C₂H₄O)ₕ—(C₃H₆O)ᵢ(CₖH₂ₖ)ⱼ—R³, wherein R³ is independently H, a monovalent hydrocarbon group or an alkoxy group, f is 1-10, g is 0 or 1, h is 1-50, i is 0-50, j is 0-50, k is 4-8; C₆Q₄ is unsubstituted or substituted; Q is independently selected from H, C₁₋₁₀ alkyl, C₁₋₁₀ alkenyl, and mixtures thereof;

D is R⁴₂SiO_{2/2} wherein R⁴ is independently H or a monovalent hydrocarbon group;

D′ is R⁵₂SiO_{2/2} wherein R⁵ is independently R² provided that at least one R⁵ is (CH₂)_{f}(C₆Q₄)_{g}O—(C₂H₄O)ₕ—(C₃H₆O)ᵢ(CₖH₂ₖ)ⱼ—R³, wherein R³ is independently H, a monovalent hydrocarbon group or an alkoxy group, f is 1-10, g is 0 or 1, h is 1-50, i is 0-50, j is 0-50, k is 4-8; C₆Q₄ is unsubstituted or substituted; Q is independently selected from H, C₁₋₁₀ alkyl, C₁₋₁₀ alkenyl, and mixtures thereof; and

D″ is R⁶₂SiO_{2/2} wherein R⁶ is independently H, a monovalent hydrocarbon group or (CH₂)ₗ(C₆Q₄)ₘ(A)ₙ-[(L)ₒ-(A′)ₚ-]_{q}-(L′)ᵣZ(G)ₛ, wherein 1 is 1-10; m is 0 or 1; n is 0-5; o is 0-3; p is 0 or 1; q is 0-10; r is 0-3; s is 0-3; C₆Q₄ is unsubstituted or substituted; Q is independently selected from H, C₁₋₁₀ alkyl, C₁₋₁₀ alkenyl, and mixtures thereof; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; L and L′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl or alkenyl, a carbohydrate unsubstituted or substituted with a C₁₋₁₀ alkyl or alkenyl or an ammonium; G is an anion or cation such as H⁺, Na⁺, Li⁺, K⁺, NH₄⁺, Ca⁺², Mg⁺², Cl⁻, Br⁻, I⁻, mesylate or tosylate.

Examples of the types of siloxane-based surfactants described herein above may be found in EP-1,043,443A1, EP-1,041,189 and WO-01/34,706 (all to GE Silicones) and U.S. Pat. Nos. 5,676,705, 5,683,977, 5,683,473, and EP-1,092,803A1 (all assigned to Lever Brothers).

Non-limiting commercially available examples of suitable siloxane-based surfactants are TSF 4446 (ex. General Electric Silicones), XS69-B5476 (ex. General Electric Silicones); Jenamine HSX (ex. DelCon) and Y12147 (ex. OSi Specialties).

Another class of suitable emulsifying agent/surfactant is anionic surfactants. Non-limiting examples of anionic surfactants useful herein include:
a) C₁₁-C₁₈ alkyl benzene sulfonates (LAS);
b) C₁₀-C₂₀ primary, branched-chain and random alkyl sulfates (AS);
c) C₁₀-C₁₈ secondary (2,3) alkyl sulfates having formula (I) and (II): 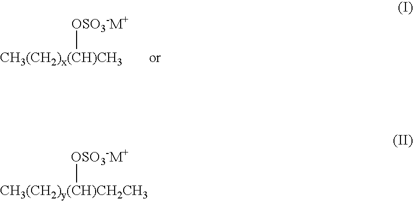
   M in formula (I) and (II) is hydrogen or a cation which provides charge neutrality. For the purposes of the present invention, all M units, whether associated with a surfactant or adjunct ingredient, can either be a hydrogen atom or a cation depending upon the form isolated by the artisan or the relative pH of the system wherein the compound is used. Non-limiting examples of preferred cations include sodium, potassium, ammonium, and mixtures thereof. Wherein x in formula (I) and (II) is an integer of at least about 7, preferably at least about 9; y in formula (I) and (II) is an integer of at least 8, preferably at least about 9;
d) C₁₀-C₁₈ alkyl alkoxy sulfates (AEₓS) wherein preferably x is from 1-30;
e) C₁₀-C₁₈ alkyl alkoxy carboxylates preferably comprising 1-5 ethoxy units;
f) mid-chain branched alkyl sulfates as discussed in U.S. Pat. Nos. 6,020,303 and 6,060,443;
g) mid-chain branched alkyl alkoxy sulfates as discussed in U.S. Pat. Nos. 6,008,181 and 6,020,303;
h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548.;
i) C₁₂-C₂₀ methyl ester sulfonate (MES);
j) C₁₀-C₁₈ alpha-olefin sulfonate (AOS); and
k) C₆-C₂₀ Sulfosuccinates available under the trade names of Aerosol OT and Aerosol TR-70 (ex. Cytec).

Another class of suitable emulsifying agent/surfactant is nonionic surfactants. Non-limiting examples of nonionic surfactants include:
a) C₁₂-C₁₈ alkyl ethoxylates, such as, NEODOL® nonionic surfactants from Shell;
b) C₆-C₁₂ alkyl phenol alkoxylates wherein the alkoxylate units are a mixture of ethyleneoxy and propyleneoxy units;
c) C₁₂-C₁₈ alcohol and C₆-C₁₂ alkyl phenol condensates with ethylene oxide/propylene oxide block polymers such as Pluronic® from BASF;
d) C₁₄-C₂₂ mid-chain branched alcohols, BA, as discussed in U.S. Pat. No. 6,150,322;
e) C₁₄-C₂₂ mid-chain branched alkyl alkoxylates, BAEₓ, wherein x is from 1-30, as discussed in U.S. Pat. Nos. 6,153,577, 6,020,303 and 6,093,856;
f) Alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779;
g) Polyhydroxy fatty acid amides as discussed in U.S. Pat. No. 5,332,528, WO 92/06162, WO 93/19146, WO 93/19038, and WO 94/09099;
h) ether capped poly(oxyalkylated) alcohol surfactants as discussed in U.S. Pat. No. 6,482,994 and WO 01/42408; and

Further non-limiting examples include nonionic surfactants selected from the group consisting of fatty acid (C₁₂₋₁₈) esters of ethoxylated (EO₅₋₁₀₀) sorbitans. More preferably said surfactant is selected from the group consisting of mixtures of laurate esters of sorbitol and sorbitol anhydrides; mixtures of stearate esters of sorbitol and sorbitol anhydrides; and mixtures of oleate esters of sorbitol and sorbitol anhydrides. Even more preferably said surfactant is selected from the group consisting of Polysorbate 20, which is a mixture of laurate esters of sorbitol and sorbitol anhydrides consisting predominantly of the monoester, condensed with about 20 moles of ethylene oxide; Polysorbate 60 which is a mixture of stearate esters of sorbitol and sorbitol anhydride, consisting predominantly of the monoester, condensed with about 20 moles of ethylene oxide; Polysorbate 80 which is a mixture of oleate esters of sorbitol and sorbitol anhydrides, consisting predominantly of the monoester, condensed with about 20 moles of ethylene oxide; and mixtures thereof. Most preferably, said surfactant is Polysorbate 60.

Other examples of ethoxylated surfactant include carboxylated alcohol ethoxylate, also known as ether carboxylate, having a general structure: R⁷O(CHCH₂O)ₛ—CO₂H; wherein R⁷ having from about 8 to about 20 carbon atoms and s being and average from about 0.1 to about 10; ethoxylated quaternary ammonium surfactants, such as PEG-5 cocomonium methosulfate, PEG-15 cocomonium chloride, PEG-15 oleammonium chloride and bis(polyethoxyethanol)tallow ammonium chloride. Other suitable nonionic ethoxylated surfactants are ethoxylated alkyl amines derived from the condensation of ethylene oxide with hydrophobic alkyl amines, with R⁸ having from about 8 to about 22 carbon atoms and s being from about 3 to about 30.

Another class of suitable emulsifying agent/surfactant is cationic surfactants. Non-limiting examples of cationic surfactants include: the quaternary ammonium surfactants, which can have up to 26 carbon atoms.
a) alkoxylate quaternary ammonium (AQA) surfactants as discussed in U.S. Pat. No. 6,136,769;
b) dimethyl hydroxyethyl quaternary ammonium as discussed in U.S. Pat. No. 6,004,922;
c) polyamine cationic surfactants as discussed in WO 98/35002, WO 98/35003, WO 98/35004, WO 98/35005, and WO 98/35006;
d) cationic ester surfactants as discussed in U.S. Pat. Nos. 4,228,042, 4,239,660 4,260,529 and 6,022,844; and
e) amino surfactants as discussed in U.S. Pat. No. 6,221,825 and WO 00/47708, specifically amido propyldimethyl amine.

Another class of suitable emulsifying agent/surfactant is zwitterionic surfactants. Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

Another class of suitable emulsifying agent/surfactant is ampholytic surfactants. Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 to Laughlin et al., issued Dec. 30, 1975 at column 19, lines 18-35, for examples of ampholytic surfactants.

Another class of suitable emulsifying agent/surfactant is semi-polar nonionic surfactants Non-limiting examples of semi-polar nonionic surfactants include: water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms. See WO 01/32816, U.S. Pat. Nos. 4,681,704, and 4,133,779.

Another class of suitable emulsifying agent/surfactant is gemini surfactants. Gemini Surfactants are compounds having at least two hydrophobic groups and at least two hydrophilic groups per molecule have been introduced. These have become known as “gemini surfactants” in the literature, e.g., Chemtech, Mar. 1993, pp 30-33, and J. American Chemical Soc., 115, 10083-10090 (1993) and the references cited therein.

Another class of suitable emulsifying agent/surfactant is amine surfactants. Non-limiting examples of amine surfactants include primary alkylamines comprising from about 6 to about 22 carbon atoms are used. Particularly preferred primary alkylamines are oleylamine (commercially available from Akzo under the trade name ARMEEN OLD®), dodecylamine (commercially available from Akzo under the trade name ARMEEN 12D®), branched C₁₆-C₂₂ alkylamine (commercially available from Rohm & Haas under the trade name PRIMENE JM-T®) and mixtures thereof.

Another class of suitable emulsifying agent/surfactant is fluorosurfactants. Fluorosurfactants also may be used as the emulsifier in the present invention. Suitable fluorosurfactants include, anionic fluorosurfactants, including but not limited to fluoroalkyl carboxylates, fluoroalkyl phosphates, fluoroalkyl sulfates; nonionic fluorosurfactants, including but not limited to fluoroalkyl ethoxylates; cationic fluorosurfactants, including but not limited to quaternary ammonium salts; and amphoteric fluorosurfactants, including but not limited to betaine. Preferred fluorosurfactants are available from the DUPONT® Company under the tradename ZONYL®, 3M® under the tradename FLUORAD®, and CLARIANT® under the tradename FLUOWET®.

As used herein, “lipophilic fluid” means any liquid or mixture of liquid that is immiscible with water at up to 20% by weight of water. In general, a suitable lipophilic fluid can be fully liquid at ambient temperature and pressure, can be an easily melted solid, e.g., one which becomes liquid at temperatures in the range from about 0° C. to about 60° C., or can comprise a mixture of liquid and vapor phases at ambient temperatures and pressures, e.g., at 25° C. and 1 atm. of pressure.

It is preferred that the lipophilic fluid herein be inflammable or, have relatively high flash points and/or low VOC characteristics, these terms having conventional meanings as used in the dry cleaning industry, to equal or, preferably, exceed the characteristics of known conventional dry cleaning fluids.

Non-limiting examples of suitable lipophilic fluid materials include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

“Siloxane” as used herein means silicone fluids that are non-polar and insoluble in water or lower alcohols. Linear siloxanes (see for example U.S. Pat. Nos. 5,443,747, and 5,977,040) and cyclic siloxanes are useful herein, including the cyclic siloxanes selected from the group consisting of octamethyl-cyclotetrasiloxane (tetramer), dodecamethyl-cyclohexasiloxane (hexamer), and preferably decamethyl-cyclopentasiloxane (pentamer, commonly referred to as “D5”). A preferred siloxane comprises more than about 50% cyclic siloxane pentamer, more preferably more than about 75% cyclic siloxane pentamer, most preferably at least about 90% of the cyclic siloxane pentamer. Also preferred for use herein are siloxanes that are a mixture of cyclic siloxanes having at least about 90% (preferably at least about 95%) pentamer and less than about 10% (preferably less than about 5%) tetramer and/or hexamer.

The lipophilic fluid can include any fraction of dry-cleaning solvents, especially newer types including fluorinated solvents, or perfluorinated amines. Some perfluorinated amines such as perfluorotributylamines, while unsuitable for use as lipophilic fluid, may be present as one of many possible adjuncts present in the lipophilic fluid-containing composition.

Other suitable lipophilic fluids include, but are not limited to, diol solvent systems e.g., higher diols such as C₆ or C₈ or higher diols, organosilicone solvents including both cyclic and acyclic types, and the like, and mixtures thereof.

Non-limiting examples of low volatility non-fluorinated organic solvents include for example OLEAN® and other polyol esters, or certain relatively nonvolatile biodegradable mid-chain branched petroleum fractions.

Non-limiting examples of glycol ethers include propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether.

Non-limiting examples of other silicone solvents, in addition to the siloxanes, are well known in the literature, see, for example, Kirk Othmer's Encyclopedia of Chemical Technology, and are available from a number of commercial sources, including GE Silicones, Toshiba Silicone, Bayer, and Dow Corning. For example, one suitable silicone solvent is SF-1528 available from GE Silicones.

Non-limiting examples of glycerine derivative solvents include materials having the following structure:

Non-limiting examples of suitable glycerine derivative solvents for use in the methods and/or apparatuses of the present invention include glyercine derivatives having the following structure: 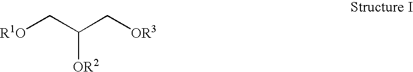
wherein R¹, R² and R³ are each independently selected from: H; branched or linear, substituted or unsubstituted C₁-C₃₀ alkyl, C₂-C₃₀ alkenyl, C₁-C₃₀ alkoxycarbonyl, C₃-C₃₀ alkyleneoxyalkyl, C₁-C₃₀ acyloxy, C₇-C₃₀ alkylenearyl; C₄-C₃₀ cycloalkyl; C₆-C₃₀ aryl; and mixtures thereof. Two or more of R¹, R² and R³ together can form a C₃-C₈ aromatic or non-aromatic, heterocyclic or non-heterocyclic ring.

Non-limiting examples of suitable glycerine derivative solvents include 2,3-bis(1,1-dimethylethoxy)-1-propanol; 2,3-dimethoxy-1-propanol; 3-methoxy-2-cyclopentoxy-1-propanol; 3-methoxy-1-cyclopentoxy-2-propanol; carbonic acid (2-hydroxy-1-methoxymethyl)ethyl ester methyl ester; glycerol carbonate and mixtures thereof.

Non-limiting examples of other environmentally-friendly solvents include lipophilic fluids that have an ozone formation potential of from about 0 to about 0.31, lipophilic fluids that have a vapor pressure of from about 0 to about 0.1 mm Hg, and/or lipophilic fluids that have a vapor pressure of greater than 0.1 mm Hg, but have an ozone formation potential of from about 0 to about 0.31. Non-limiting examples of such lipophilic fluids that have not previously been described above include carbonate solvents (i.e., methyl carbonates, ethyl carbonates, ethylene carbonates, propylene carbonates, glycerine carbonates) and/or succinate solvents (i.e., dimethyl succinates).

As used herein, “ozone reactivity” is a measure of a VOC's ability to form ozone in the atmosphere. It is measured as grams of ozone formed per gram of volatile organics. A methodology to determine ozone reactivity is discussed further in W. P. L. Carter, “Development of Ozone Reactivity Scales of Volatile Organic Compounds”, Journal of the Air & Waste Management Association, Vol. 44, Pages 881-899, 1994. “Vapor Pressure” as used can be measured by techniques defined in Method 310 of the California Air Resources Board.

Preferably, the lipophilic fluid comprises more than 50% by weight of the lipophilic fluid of cyclopentasiloxanes, (“D5”) and/or linear analogs having approximately similar volatility, and optionally complemented by other silicone solvents.

Optional/Adjunct Ingredients

While not essential for the purposes of the present invention, the non-limiting list of optional ingredient illustrated hereinafter are suitable for use in the instant cleaning compositions and may be desirably incorporated in certain embodiments of the invention, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the composition and the nature of the cleaning operation for which it is to be used. Suitable adjunct materials include, but are not limited to, additional surfactants, builders, dye transfer inhibiting agents, dispersants, enzymes, and enzyme stabilizers, catalytic metal complexes, polymeric dispersing agents, clay soil removal/anti-redeposition agents, brighteners, suds suppressors, dyes, perfumes, structure elasticizing agents, fabric softeners, carriers, hydrotropes, processing aids and/or pigments. Examples of optional/adjunct ingredients and levels of use are found in U.S. Pat. Nos. 5,576,282, 6,306,812 B1 and 6,326,348 B1 that are incorporated by reference.

### EXAMPLES

### Example 1

The following compositions are made as described below:

| | PB1/TAED Examples: | | |
|---|---|---|---|
| | Nominal | Composition A | Composition B |
| | activity (%) | grams | grams |
| Buffer (pH 10) | as is | 256.98 | 256.98 |
| Dequest 2060A | 50.00 | 0.60 | 0.60 |
| NaOH | 1N | 18.62 | 18.62 |
| Water | as is | 24.40 | 24.40 |
| Perforate monohydrate | 95.00 | 11.84 | 19.74 |
| TAED | 92.20 | 11.62 | 11.62 |
| Total | | 324.06 | 331.96 |

1. A bleaching composition is prepared by the sequential additional of the components in the order listed in the table.
2. The reaction mixture is allowed to react for approximately ten minutes.
3. After the approximate ten minute reaction, the bleaching composition is mixed with 14,376 grams of decamethylcyclopentasiloxane and 300 grams of an emulsifying composition (Example 3) to form the cleaning composition. The mixing is done by mixer (⅓ hp, 1750 rpm, 115VAC, ½ ″shaft, McMaster-Carr Cat# 3473K14 (mixer).
4. The composition is then pumped by a Gorman-Rupp Industries pump (2000 series, gear, 12VDC, 1GPM, Cat# 2000-C; pump) to a spray nozzle (SS, 1 gpm @20 psi, ¼″ NPT, 0109″ orifice diameter, McMaster-Carr Cat# 32885K55).
5. The mixture is then sprayed into a wash drum containing the fabric being washed.
6. Additional decamethylcyclopentasiloxane is then added to give a total amount of decamethylcyclopentasiloxane of about 29.4 kg.

The materials used above can be obtained as follows: pH 10 buffer can be obtained from EM Science of Darmstadt, Germany under the commercial name of Catalogue # EM B1636-1; water can be obtained from RICCA Chemical Co. of Arlington, Tex. U.S.A. under the commercial name Deionized Reagent Grade Water; Diethylenetriaminepenta(methylenephosphonic acid) can be obtained from Solutia of St. Louis, Mo. U.S.A. under the commercial name Dequest 2060A; 1 N sodium hydroxide can be obtained from VWR of West Chester, Pa. U.S.A. under the commercial name Catalogue # VW3222-1; sodium perborate monohydrate can be obtained from Solvay Interox, Inc. of Houston, Tex., U.S.A.; and Tetraacetylethylenediamine (TEAD) can be obtained from Warwick International of Holywell, Flintshire, United Kingdom under the commercial name of MYKON ATC.

### Example 2

The following compositions are made as described below:

| | PAP Examples: | | |
|---|---|---|---|
| | nominal | Composition A | Composition B |
| | activity | grams | grams |
| Buffer (pH 9) | as is | 300.00 | 300.00 |
| Dequest 2060A | 50.00 | 0.60 | 0.60 |
| NaOH | 1N | 24.03 | 24.03 |
| PAP | 75.00 | 18.00 | 25.00 |
| Water | as is | 0.00 | 0.00 |
| Total | | 342.63 | 349.63 |

1. A bleaching composition A and B are prepared by the sequential additional of the components in the order listed in the table.
2. The bleaching composition A is mixed with 14,376 grams of decamethylcyclopentasiloxane and 300 grams of an emulsifying composition (Example 3) to form the cleaning composition. The mixing is done by mixer (⅓ hp, 1750 rpm, 115VAC, ½″shaft, McMaster-Carr Cat# 3473K14 (mixer).
3. The composition is then pumped by a Gorman-Rupp Industries pump (2000 series, gear, 12VDC, 1GPM, Cat# 2000-C; pump) to a spray nozzle (SS, 1 gpm @20 psi, ¼″ NPT, 0109″ orifice diameter, McMaster-Carr Cat# 32885K55).
4. The mixture is then sprayed into a wash drum via containing the fabric being washed.
5. Additional decamethylcyclopentasiloxane is then added to give a total amount of decamethylcyclopentasiloxane of about 29.4 kg.

The materials used above can be obtained as follows: water can be obtained from RICCA Chemical Co. of Arlington, Tex. U.S.A. under the commercial name Deionized Reagent Grade Water; pH 9 buffer can be obtained from VWR of West Chester, Pa. U.S.A under the commercial name of Catalogue # 34170-121; Diethylenetriaminepenta(methylenephosphonic acid) can be obtained from Solutia of St. Louis, Mo. U.S.A. under the commercial name Dequest 2060A; 1 N sodium hydroxide can be obtained from VWR of West Chester, Pa. U.S.A. under the commercial name Catalogue # VW3222-1; Phthalimidoperoxyhexanoic acid (PAP) can be obtained from Ausimont S.p.A. of Milan, Italy under the commercial name of EURECO W—75% active PAP.

| | Wt. % of | | | |
|---|---|---|---|---|
| | Total Formula | Supplier | City | State/ |
| Tergitol 15-S-3 | 25.00 | Union Carbide | Danbury | CT |
| | | Corp. | | |
| Envirogem AD01 | 25.00 | Air Products | Allentown | PA |
| Propylene Glycol | 15.40 | Sigma Aldrich | St. Louis | MO |
| Rewoquat V 3620 | 4.60 | Witco Corp. | Dublin | Ohio |
| XS-69-B5476 | 2.50 | GE | Waterford | NY |
| TSF-4446 | 7.50 | GE | Waterford | NY |
| Oleic Acid | 20.00 | Cognis Corp. | Cincinnati | Ohio |
| (Emersol 233) | | | | |

100.00

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising:
a.) from about 10 ppm to about 2,000 ppm of a peracid;
b.) from about 1,000 ppm to about 50,000 ppm water;
c.) from about 20 ppm to about 50,000 ppm of an emulsifier which is an anionic surfactant; and
d.) the balance of said cleaning composition being decamethylcyclopentasiloxane lipophilic fluid or a mixture of said lipophilic fluid and an adjunct ingredient; said composition comprising a dispersion comprising at least a first phase and a second phase wherein said first phase comprises peracid:
i.) wherein in a 1 mL sample of said cleaning composition, greater than about 0.95 weight fraction of the first phase is contained in droplets, each droplet having an individual weight of less than 1 wt % of the total mass of the first phase in said 1 mL sample; or
ii.) said first phase forms discrete droplets having a median particle diameter χ₅₀ of less than about 1000 μm; and wherein said first phase of said composition is an aqueous phase and said second phase of said composition is a continuous phase comprising said decamethylcyclopentasiloxane.

2. The cleaning composition of claim 1, wherein the emulsifier is an anionic surfactant which is a member selected from the group consisting of C₁₁- C₁₈ alkyl benzene sulfonates; C₁₀-C₂₀ primary, branched-chain and random alkyl sulfates; C₁₀-C₁₈ secondary (2,3) alkyl sulfates; C₁₀-C₁₈ alkyl alkoxy sulfates; C₁₀-C₁₈ alkyl alkoxy carboxylates; mid-chain branched alkyl sulfates; mid-chain branched alkyl alkoxy sulfates; modified alkyl benzene sulfonate MLSA; C₁₂-C₂₀ methyl ester sulfonate; C₁₀-C₁₈ alpha-olefin sulfonate; and C₆-C₂₀ sulfosuccinates.

3. The cleaning composition of claim 1 further comprising at least 10 ppb of a chelant.

4. The cleaning composition of claim 1 wherein said first phase comprises, based on the total weight of peracid in said composition, from about 50% to about 100% of said cleaning composition's peracid.

5. The cleaning composition of claim 1 comprising:
a.) from about 30 ppm to about 1,000 ppm of a peracid;
b.) from about 2,000 ppm to about 30,000 ppm water; and
c.) from about 100 ppm to about 3,000 ppm of said emulsifier.

6. The cleaning composition of claim 5 comprising:
a.) from about 80 ppm to about 500 ppm of a peracid;
b.) from about 5,000 ppm to about 20,000 ppm water; and
c.) from about 500 ppm to about 2,000 ppm of said emulsifier.

7. The cleaning composition of claim 6 further comprising at least 10 ppb of a chelant.

8. The cleaning composition of claim 7 wherein said first phase comprises, based on the total weight of peracid in said composition, from about 50% to about 100% of said cleaning composition's peracid.

9. The cleaning composition of claim 1 further comprising an adjunct material selected from the group consisting of builders, dye transfer inhibiting agents, dispersants, enzymes, and enzyme stabilizers, catalytic metal complexes, polymeric dispersing agents, clay soil removal/anti-redeposition agents, brighteners, suds suppressors, dyes, perfumes, structure elasticizing agents, fabric softeners, carriers, hydrotropes, processing aids, pigments and mixtures thereof.
